(19) United States
(12) Patent Application Publication
(10) Pub. No.: US 2022/0329446 A1
(43) Pub. Date: Oct. 13, 2022

(54) ENHANCED ASSET MANAGEMENT USING AN ELECTRONIC LEDGER

(71) Applicant: Total Network Services Corp., Carlsbad, CA (US)

(72) Inventors: Kevin L. Jackson, Manassas, VA (US); Thomas Carter, Vista, CA (US)

(21) Appl. No.: 17/712,908

(22) Filed: Apr. 4, 2022

Related U.S. Application Data
(60) Provisional application No. 63/172,066, filed on Apr. 7, 2021.
(60) Provisional application No. 63/239,879, filed on Sep. 1, 2021.

(51) Int. Cl. H04L 9/00; H04W 12/06; H04W 12/71

(52) U.S. Cl. CPC H04L 9/50; H04W 12/06; H04W 12/71

(57) ABSTRACT

Described herein are techniques for managing authentication of asset rights via an electronic ledger. In some embodiments, the techniques comprise maintaining, on an electronic ledger, information associated with an asset, the information comprising an eMEID and one or more permissions for the asset that are modifiable only upon authentication of the eMEID, receiving, from a user device, a request to perform an action in relation to the asset, the request comprising at least an identifier for the user device, retrieving, from the electronic ledger, a current state of the asset, determining, based on the identifier for the user device and the one or more permissions for the asset in the current state, that the user device is authorized to perform the action, and causing the action to be executed in relation to the asset.

### CROSS-REFERENCE TO RELATED APPLICATIONS

This application claims priority to U.S. Patent Application No. 63/172,066, to Jackson et. al, filed on Apr. 7, 2021, entitled “Enhanced Asset MEID Tracking Using a Distributed Ledger,” as well as U.S. Patent Application No. 63/239,879, to Jackson et. al, filed on Sep. 1, 2021, entitled “Digital and Physical Asset Tracking and Authentication via Non-Fungible Tokens on a Distributed Ledger.” Each of the above applications are hereby incorporated by reference in their entirety.

### BACKGROUND

With the rise in popularity of digital art, ownership of digital assets is becoming increasingly commonplace. However, digital assets, such as images, can be easily copied or photographed. Hence, a system for authenticating ownership of assets is needed.

### SUMMARY

Provided herein is a system for enabling interaction with information for an asset stored in relation to an electronic ledger (e.g., a blockchain ledger) using a user device. In the system, a data record stored in the electronic ledger is associated with an identifier (e.g., an eMEID) generated by a user device that has ownership rights in the asset. The identifier may be provided by a user device and used to authenticate ownership of an asset when updating access rights (e.g., permissions) associated with the asset or when transferring ownership of the asset. In some embodiments, the eMEID is generated using information related to the asset and/or the user device, such as an identifier (e.g., MEID) of the user device.

It should be noted that while a particular type of identifier is disclosed as being used to generate a hash data value that can be used to authenticate an ownership interest in an asset, any other suitable identifier may be used. For example, an International Securities Identification Number (ISIN) may be used to generate such a hash data value in some cases. An ISIN is a 12-digit alphanumeric code that uniquely identifies a specific security. The organization that allocates ISINs in any particular country is the country's respective National Numbering Agency (NNA).

In one embodiment, a method is disclosed as being performed by a user device, the method comprising maintaining, on an electronic ledger, information associated with an asset, the information comprising an enhanced Mobile Equipment Identifier (eMEID) and one or more permissions for the asset that are modifiable only upon authentication of the eMEID, receiving, from a user device, a request to perform an action in relation to the asset, the request comprising at least an identifier for the user device, retrieving, from the electronic ledger, a current state of the asset, determining, based on the identifier for the user device and the one or more permissions for the asset in the current state, that the user device is authorized to perform the action, and causing the action to be executed in relation to the asset.

An embodiment is directed to a computing system comprising a processor; and a memory including instructions that, when executed with the processor, cause the computing device to, at least maintain, on an electronic ledger, information associated with an asset, the information comprising an eMEID and one or more permissions for the asset that are modifiable only upon authentication of the eMEID, receive, from a user device, a request to perform an action in relation to the asset, the request comprising at least an identifier for the user device, retrieve, from the electronic ledger, a current state of the asset, determine, based on the identifier for the user device and the one or more permissions for the asset in the current state, that the user device is authorized to perform the action, and cause the action to be executed in relation to the asset.

An embodiment is directed to a non-transitory computer-readable media collectively storing computer-executable instructions that upon execution cause one or more computing devices to collectively perform acts comprising maintaining, on an electronic ledger, information associated with an asset, the information comprising an enhanced Mobile Equipment Identifier (eMEID) and one or more permissions for the asset that are modifiable only upon authentication of the eMEID, receiving, from a user device, a request to perform an action in relation to the asset, the request comprising at least an identifier for the user device, retrieving, from the electronic ledger, a current state of the asset, determining, based on the identifier for the user device and the one or more permissions for the asset in the current state, that the user device is authorized to perform the action, and causing the action to be executed in relation to the asset.

The foregoing, together with other features and embodiments will become more apparent upon referring to the following specification, claims, and accompanying drawings. Embodiments of the invention covered by this patent are defined by the claims below, not in this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 depicts a schematic block diagram illustrating a computing environment that supports enhanced asset tracking using an electronic ledger in accordance with some embodiments;

FIG. 2 depicts a block diagram showing various components of a computing system architecture that supports enhanced asset management using an electronic ledger in accordance with at least some embodiments;

FIG. 3 illustrates a block diagram representing an exemplary electronic ledger that may be implemented in accordance with some embodiments;

FIG. 4 illustrates a block diagram representing a series of exemplary interactions that may be performed in relation to an electronic ledger in accordance with some embodiments;

FIG. 5 illustrates a flow diagram illustrating a process for generating and appending information associated with an asset to an electronic ledger in accordance with embodiments;

FIG. 6 illustrates a process flow for generating a block on a blockchain that incorporates an asset NFT in accordance with some embodiments;

FIG. 7 illustrates a process flow for accessing an unabridged digital asset at an electronic device in accordance with some embodiments;

FIG. 8 illustrates a process flow for verifying authenticity and ownership of a physical asset at an electronic device in accordance with some embodiments; and

FIG. 9 depicts a flow diagram showing a process flow for processing requests for an asset in relation to an electronic ledger in accordance with embodiments.

### DETAILED DESCRIPTION

This disclosure describes techniques that facilitate physical and digital asset tracking using non-fungible tokens (NFTs) stored on an electronic ledger. An asset controller is described that can associate NFTs to assets (e.g., physical assets and/or digital assets) for the purpose of providing verifiable proof of ownership. While the Asset controller is described as a stand-alone controller, the functionality and operations of the Asset controller can be implemented via an Asset controller application native to any electronic device capable of interacting with an electronic ledger via one or more networks.

Moreover, this disclosure describes techniques that facilitate creating an NFT associated with one or more identifiers of mobile devices. For example, an NFT may be generated and associated with one or more Mobile Equipment Identifiers (MEIDs)). An MEID is a globally unique 56-bit identification number that is associated with a mobile device. Typically, equipment identifiers, such as MEIDs, are permanently etched into the physical structure of the mobile device, enabling consumers and vendors to identify and track mobile devices. An NFT includes a cryptographic token, namely a unit of data that is not mutually interchangeable, that can be stored on an electronic ledger (e.g., a blockchain ledger) in association with an asset. An NFT may be any suitable token that associates the asset (digital or physical) with one or more usage permissions. While the digital and physical assets themselves are infinitely reproducible, the NFTs representing them are tracked on their underlying electronic ledgers and provide a verifiable proof of ownership.

Accordingly, this disclosure describes techniques for generating an NFT associated with an identifier (e.g., an MEID) for the purpose of providing a verifiable proof of ownership of physical and digital assets. In one embodiment, the asset controller may receive an identifier (e.g., a serial number or MEID) that is associated with an asset (e.g., physical asset or digital asset), and generate an enhanced MEID as a cryptographic token of the identifier (e.g., a cryptographic hash value of the MEID). The enhanced MEID may be uploaded onto an electronic ledger, such as a blockchain, in order to verifiably memorialize an association between the NFT and its association with a physical or digital asset.

Additionally, the techniques describe generating an NFT for a digital asset that can be used to verify the authenticity of the digital asset. The digital asset may include multimedia data (e.g., audio, video, image) or literary data that is available via a public or private network. The digital asset may further include log files, transaction histories, or any other suitable data file that can be accessed, created, modified, or transmitted via an electronic device. The NFT may include a cryptographic token, namely a unit of data that is not mutually interchangeable, and that can be stored on a distributed ledger blockchain. While digital assets themselves are infinitely reproducible, a particular instantiation of a digital asset that is tied to an NFT is uniquely distinguished from reproduced instances.

The electronic ledger may be any suitable data structure that is used to store data records associated with an NFT. Generally, electronic ledger systems are configured to store tamper-resistant records of previously verified transactions or computer code executions. One example of an electronic ledger is a blockchain ledger. A blockchain ledger includes a series of connected data structures, referred to as blocks. Each block contains a set of one or more data records and a header. The header includes a hash derived from the payload of the block and a hash of the previous block.

In one embodiment, consider a physical asset. The physical asset may include an electronic device, such as a mobile device. Alternatively, the physical asset may include a non-electronic device asset, such as furniture or a painting. In this embodiment, the Asset controller may generate an NFT based on an identifier associated with the physical asset. In some cases, an electronic identifier for the NFT may be etched onto the physical asset. Additionally, information identifying the NFT may be included in the payload data of an initial block of a blockchain ledger that represents the lifecycle of the physical or digital asset. The lifecycle may include manufacture, sale, transport, and distribution of the physical or digital asset.

Further, the blockchain ledger may include a permissions schedule that memorializes ownership, access, and modification rights to the asset based on user device identifier. In this way, the owner of the asset may control sale, transfer, publication, dissemination, and modification of records relating to the asset via a verifiable blockchain.

In some embodiments, an asset application may reside on an electronic physical asset. The asset application may be configured to upload digital assets associated with the electronic physical asset to the blockchain ledger. Each upload of digital assets may include a subsequent block in the blockchain ledger, and each upload of digital assets may be encrypted using a private key of an asymmetric key pair that is associated with an owner of the electronic physical device. Digital assets may include image files, audio file, video files, log files, transaction histories for native user applications, or any other suitable data file that can be accessed, created, modified, or transmitted via the electronic physical asset.

Moreover, the asset application may be configured to associate metadata with digital assets. Metadata may include a timestamp and geographic coordinates identifying when and where the digital asset was accessed, created, modified, or transmitted via the electronic physical asset. By memorializing such data in an electronic ledger (e.g., a blockchain ledger), a verifiable proof of ownership can be maintained that traces the lifecycle of the digital asset.

In another embodiment, consider a digital asset. The digital asset may include a digital image, software application, audio file, video file, digital license, or any other suitable digital file. In this embodiment, the asset controller may generate and associate an NFT with the digital asset in an initial block of a blockchain that represents the lifecycle of the digital asset. In one example, the Asset controller may associate the NFT with an identifier for a physical device from which the NFT is generated. For example, the NFT may include a cryptographic hash of the MEID of the user device and the digital asset itself.

Moreover, an Asset controller device, or an Asset application on a user device, may associate metadata with the digital asset. Such metadata may include a timestamp and geographic coordinates that identify when and where the digital asset was accessed, created, modified, or transmitted.

Embodiments of the disclosure provide for a number of advantages over conventional systems. For example, embodiments of the disclosure provide for verification of ownership of an asset in a secure manner. Additionally, embodiments of the disclosure provide the ability for an owner of an asset to manage which user devices are capable of interacting with that asset as well as what actions may be taken by those user devices with respect to the asset. This enables an asset to be sold or otherwise transferred while preventing fraudulent transfer/use by unauthorized parties.

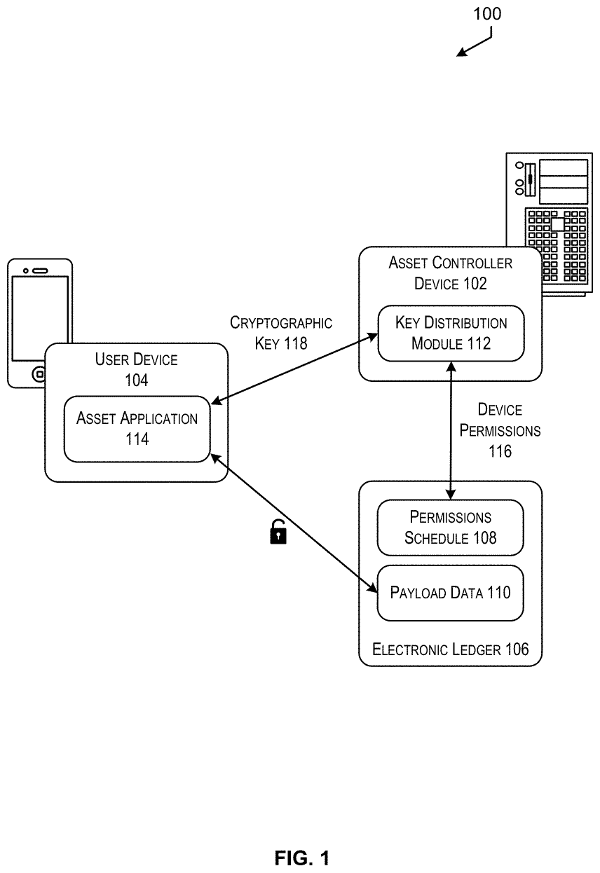

FIG. 1 depicts a schematic block diagram illustrating a computing environment that supports enhanced asset tracking using an electronic ledger in accordance with some embodiments. In the computing environment 100, an asset controller device 102 may be in communication with one or more user devices 104. Each of the asset controller device and the user device may have access to an electronic ledger 106.

The electronic ledger 106 may include any suitable form of digital record that may be maintained on a computing device. In some cases, the electronic ledger may be a blockchain ledger that includes a number of “blocks” of data. Data in each block may be encrypted or otherwise obfuscated. In some cases, each block of data in the blockchain ledger may be encrypted using a different cryptographic key associated with the particular block of data. The cryptographic key used to secure a particular block of data may be a symmetric cryptographic key or an asymmetric cryptographic key. In some cases, each block of data may be associated with an NFT. In some embodiments, each NFT may be assigned a unique identifier that may be used to identify that NFT across different data blocks within the electronic ledger.

In embodiments in which the electronic ledger is a blockchain ledger, each block of data may include a hash value that is generated from data included in the previous data block of the ledger. This allows for various data blocks within the blockchain to be checked for continuity and/or validity. In some embodiments, one or more portions of the payload data may be signed by an entity that generated the block of data that includes the payload data. For example, a data block may be signed using a private cryptographic key associated with the asset controller device that generated that data block.

The electronic ledger may include multiple blocks of data that each include a permissions schedule 108 as well as payload data 110. In some embodiments, a permissions schedule 108 may include any suitable indication as to what interactions may be performed by various user devices in relation to an NFT. User devices may be identified via a device identifier, such as an MEID or eMEID, associated with the respective user device. For example, the permissions schedule may include an indication of which user device identifiers are able to access (e.g., retrieve, read, and/or update) information included in the payload data in relation to a particular NFT. In some embodiments, the electronic ledger may be publicly accessible, in that data included in the electronic ledger may be accessed by any user device (albeit encrypted). In some cases, the electronic ledger may be a distributed ledger, in that multiple copies may be stored on a number of different geographically distributed computing devices.

The asset controller device 102 may include any suitable electronic device capable of managing access to data stored on the electronic ledger 106 in relation to an NFT. In some embodiments, the asset controller device may include a key distribution module 112 configured to manage access to NFT data. In some embodiments, the key distribution module is configured to receive a request to access an NFT stored on a blockchain ledger. Upon receiving such a request, the key distribution module 112 may verify whether an identifier associated with the user device from which the request originated has permission to perform the requested action (e.g., via the permissions schedule). Once the asset controller device has verified that the user device has permission to perform the requested action, the asset controller device may retrieve and provide a cryptographic key associated with the NFT to that user device. The user device is then able to access the NFT using that cryptographic key.

In some embodiments, The Asset controller may operate on one or more distributed computing resource(s). The one or more distributed computing resource(s) may include one or more computing device(s) that operate in a cluster or other configuration to share resources, balance load, increase performance, provide fail-over support or redundancy, or for other purposes. The one or more computing device(s) may include one or more interfaces to enable communications with other networked devices via one or more networks.

The user device may include any sort of electronic devices, such as a television unit, a multimedia streaming device, a cellular phone, a smartphone, a tablet computer, an electronic reader, a media player, a gaming device, a personal computer (PC), a laptop computer, etc. The user device may also include network devices that act as intermediaries with the Internet. It is noteworthy that the Internet is accessible via one or more network(s). In some examples, the user device may include a subscriber identity module (SIM), such as an eSIM, that identifies each device to a telecommunication service provider (also referred to herein, as “telecommunications network”). Additionally, each user device may include a serial number or Mobile Equipment Identifier (MEID) that uniquely identifies the user device itself.

In some embodiments, the user device may include an Asset application 114 configured to enable interaction with information associated with an NFT stored on the electronic ledger. In some embodiments, the Asset application 114 is configured to facilitate interactions between a user of the user device and an NFT stored on the electronic ledger by making a request to the asset controller device. In response to making the request, the user device may receive a cryptographic key that can be used to decrypt the information associated with the NFT included in the payload data of the electronic ledger, providing access to the information associated with the NFT.

In some embodiments, an initial block of data may be added to the blockchain ledger in relation to an NFT using a particular user device. In these embodiments, an identifier (e.g., an enhanced MEDI) may be used to generate the initial block of data that may be included in the permissions schedule as having permission to update and/or modify the information associated with an NFT on the electronic ledger. In embodiments, such an identifier may be generated as a hash value from various information related to the user device and/or the asset data. In a first example, a hash value may be generated from an identifier (e.g., an MEID) for the user device, resulting in an “enhanced Mobile Device Identifier” (eMEID) that is stored in relation to the NFT/asset.

In a second example, in some embodiments an inventory may be performed of software applications installed on the user device; a device fingerprint may then be generated based on the inventoried combination of software. In this example, the device fingerprint may be combined (e.g., using a hash algorithm) with an identifier (e.g., an MEID) for the user device to generate the eMEID, which may then be associated with the initial block of data added to the blockchain ledger for the NFT.

In a third example, an eMEID may be a dynamic identifier. In this example, upon receiving a request to perform an action that requires owner authentication, the Asset controller device may provide a dynamic data value (e.g., a random or pseudorandom number) to the user device. In this example, the dynamic data value may be combined with the identifier for the user device (e.g., the MEID) to generate a hashed data value as an eMEID, which is then presented back to the Asset controller device. The Asset controller device may then independently generate the eMEID based on information that it has stored about the owner and the dynamic data value. In this example, if the received eMEID matches the independently generated eMEID, then ownership can be authenticated.

In the above examples, only the presentation of the eMEID may serve to authenticate the owner of the NFT/asset, such that any action which would require owner authorization (e.g., transfer asset ownership, set permissions in the permissions schedule, etc.) will only be executed upon presentation of the eMEID. In some embodiments, the permissions schedule of the electronic ledger may be updated to include an association of permissions with other user device identifiers. In such cases, the request to update the permissions schedule may be received from the user device that generated the initial block on the electronic ledger.

By way of illustration, consider a scenario in which a block of data associated with an asset is generated and added to a blockchain. In this scenario, an eMEID may be generated as a hash value from an identifier associated with the asset, such as an MEID of a user device from which the request to add the asset was received. Once the initial block has been added, the user device may update the permissions schedule to indicate what other user devices should have access to the information stored about the asset as well as the extent of such permissions. In order to perform the action to update the permissions schedule, the Asset controller may require that the user device present the eMEID to authenticate its ownership of the NFT/asset.

When the NFT is generated, a cryptographic key may be generated or selected and used to secure the information associated with that NFT. In this scenario, information associated with the NFT is initially able to be interacted with via the user device from which the request to add the NFT to the blockchain had originated. In such a scenario, the user device may submit a request to add access/update permissions for a number of different user devices in relation to the NFT.

Continuing with the above scenario, a request may be received at a key distribution module to access the information associated with the NFT from a user device. Upon receiving such a request, the key distribution module may retrieve device permissions associated with the data to be accessed at 116. Based on the retrieved device permissions, the asset controller device may make a determination as to whether the user device from which the request originated has permission to access the information associated with the NFT. If the determination is made that the user device is to be granted access, then the cryptographic key capable of being used to decrypt information associated with the NFT is provided to that user device at 118.

In some cases, if the request is a request to modify or update information associated with the NFT (including permissions associated with the NFT), then the asset controller device may be required to make such an update (upon authentication of ownership via verification of an eMEID). In other words, while the cryptographic key enables a user device to access information associated with the NFT, all updates to the electronic ledger may be required to go through the asset controller device in this scenario.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

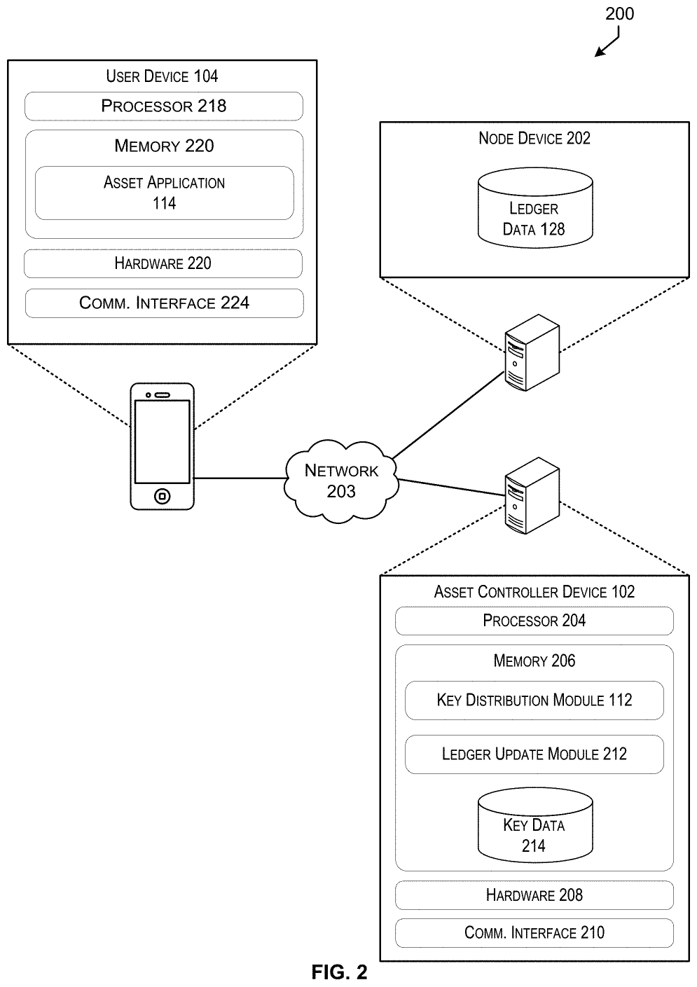

FIG. 2 depicts a block diagram showing various components of a computing system architecture 200 that support enhanced asset management using an electronic ledger in accordance with at least some embodiments. The system architecture may include an asset controller device 102, one or more user device 104, and one or more node device 202. The asset controller device 102 and user device 104 may be examples of the respective asset controller device 102 and user device 104 as described with respect to FIG. 1 above. The asset controller device and/or the user device may have access to ledger data 128. In some cases, the ledger data 128 may be hosted on the node computing device 202. Each of the components depicted in the system architecture 200 may communicate via a network 203.

The network 203 may include public networks such as the Internet, private networks such as an institutional and/or personal intranet, or some combination of a private and public network(s). The network 203 can also include any type of wired and/or wireless network, including but not limited to local area network (LANs), wide area network(s) (WANs), satellite networks, cable networks, Wi-Fi networks, Wi-Max networks, mobile communications networks (e.g., 5G-NR, LTE, 3G, 2G), or any combination thereof.

The system architecture may include an asset controller device 102 that includes one or more computing devices. The asset controller device 102 may include one or more processors 204, memory 206, and hardware 208, and a communication interface 210. The communication interface 210 may include wireless and/or wired communication components that enable the asset controller device 102 to transmit data to and receive data from other networked devices. The hardware 208 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The asset controller device 102 can include any computing device configured to perform at least a portion of the operations described herein. The asset controller device 102 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. The asset controller device 102 can include one or more virtual machines running virtual operating systems, or other computing architectures involving virtualization such as one or more flexible pools of logical storage devices that can be virtualized to maintain virtual storage devices for the computer. For example, the asset controller device 102 may include virtual computing devices in the form of virtual machines or software containers that are hosted in a cloud.

The memory 206 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, DRAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

The one or more processors 204 and the memory 206 of the asset controller device 102 may implement functionality that includes one or more software modules and data stores. Such software modules may include routines, program instructions, objects, and/or data structures that are executed by the processors 204 to perform particular tasks or implement particular data types. More particularly, the memory 206 may include a module that is configured to manage access to one or more NFTs via cryptographic key distribution (e.g., key distribution module 112) as well as a module that is configured to make updates to at least one electronic ledger (e.g., ledger update module 212). Additionally, the memory 206 may include various data stores. For example, the memory 206 may include a database of encryption key data (key data 214) that maintains a correlation between one or more data blocks (or NFTs) and one or more cryptographic keys. The one or more cryptographic keys may include symmetric cryptographic keys or asymmetric cryptographic keys.

The key distribution module 112 may be configured to, in conjunction with the processor 204, respond to requests to access data stored on an electronic ledger. As noted elsewhere, data stored in one or more data blocks of the ledger data may be encrypted using a cryptographic key associated with the respective data block. In this example, a request may be received from a user device to access data stored in the one or more data blocks. Upon receiving such a request, the key distribution module may retrieve a permissions schedule associated with the data block to determine what permissions the user device has with respect to the requested data. In such cases, the key distribution module may identify an action associated with the request and make a determination as to whether, based on the retrieved permissions schedule, the user device from which the request originated is permitted to perform the identified action. In some cases, such a determination may be made based on an identifier for the user device that is received in the request. In some cases, the permissions schedule may include a mapping of identifiers (e.g., MEIDs) for user devices correlated to actions that may, or may not, be performed via a user device associated with the respective identifier.

The ledger update module 212 may be configured to, in conjunction with the processor 204, amend or otherwise modify data stored on the electronic ledger data 128. In some embodiments, the ledger update module receives a request to manipulate the ledger data with respect to a particular piece of data. In such embodiments, the ledger update module is configured to retrieve the latest block of the ledger data pertaining to a piece of data (e.g., an NFT) that is to be manipulated. The ledger update module is configured to then generate a new block to be added to the ledger data based on a current status of the piece of data (as determined based on the retrieved block) and the requested action. In this case, a permissions schedule may be associated with the generated block that grants access/update permissions to the user device (e.g., via an identifier associated with that user device).

In some embodiments, the ledger update module 212 may be configured to update information associated with an NFT stored on the ledger data. To do this, the ledger update module 212 retrieves a latest data block that pertains to the NFT. In other words, each data block that includes a reference to the NFT may be identified within the ledger and, of those data blocks, the data block having the latest timestamp may be selected. Based on the latest data block, a current status of the NFT may be determined. Based on the current state (e.g., based on a permissions schedule for the current state), a determination may be made as to whether the user device from which the request originated has permission to perform the requested action. Provided that a determination is made that the user device does have permission to perform the requested action, a new data block is generated in relation to the NFT that reflects the requested action. For example, if the requested action is to update or change the identity of an owner of the asset associated with the NFT, then the new data block may indicate the new owner of the asset associated with the NFT. In embodiments, the new data block may include a hashed value of the data included in the last data block of the ledger data, enabling verification of the previous data block. In some embodiments, the new data block may be signed by one or more entities. For example, the new data block may be signed by the asset controller device using a private cryptographic key associated with the asset controller device. In another example, the new data block may be signed using a cryptographic key associated with the user device from which the request originated. This electronic signature can be used to verify the authenticity of the data block.

In some embodiments, the ledger update module 212 may be configured to add an asset to the ledger data. In some cases, the ledger module may first check to ensure that the asset is original (i.e., that the asset is not already on the ledger). To do this, the asset, or at least data associated with the asset, is subjected to a hash algorithm to generate a hash value. This hash value is then compared to has values for each of the other assets stored on the electronic ledger to identify potential matches. In these cases, a match may indicate a high likelihood of the asset being a copy or duplicate. In this case, the ledger update module may fail to add the asset to the electronic ledger and may instead return an error. In various embodiments, the NFT is a cryptographic token that has been generated as a hash value from information about the asset. Accordingly, an NFT generated for the asset may be compared to other NFTs already stored on the electronic ledger.

By way of illustrating the above, a user may submit a request to the asset controller device to create an NFT associated with an image (i.e., the asset). In this example, information from the image, such as information about pixel values in the image, may be subjected to a hash function to generate a value. Provided that every image is subjected to the same hash function, this would result in the same hash value being generated from the same image, regardless of other attributes of the image (e.g., title, name, etc.). In some cases, a predetermined portion of the asset data may be subjected to the hash function. For example, given the scenario described above, information about specific pixels (e.g., pixels at particular locations within the image) may be subjected to the hash function.

In some cases, the asset (or information related to the asset) may be provided as input to a trained machine learning model to determine whether it is, or is not, similar to each of the other assets already stored within the ledger data. In some cases, various attributes associated with the asset to be added may be compared to corresponding attributes associated with each of the other assets already stored within the ledger data to identify similarities.

As noted elsewhere, the asset controller device may be in communication with one or more user devices 104. The user device may include any suitable electronic device capable of performing at least a portion of the functionality attributed to the user device herein. In some embodiments, the user device may be a portable electronic device such as a mobile phone (e.g., a smart phone), tablet, laptop computer, or other suitable electronic device.

The user device 104 may include one or more processors 218, memory 220, and hardware 222, and a communication interface 224. The communication interface 224 may include wireless and/or wired communication components that enable the asset controller device 102 to transmit data to and receive data from other networked devices. The hardware 208 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 220 may be implemented using computer-readable media, such as computer storage media. The one or more processors 218 and the memory 220 of the user device 104 may implement functionality that includes one or more software modules and data stores. Such software modules may include routines, program instructions, objects, and/or data structures that are executed by the processors 218 to perform particular tasks or implement particular data types. More particularly, the memory 220 may include a software application that is configured to facilitate interactions between a user of the user device and one or more NFTs stored on an electronic ledger (e.g., Asset Application 114).

The Asset Application 114 may be configured to, in conjunction with the processor 218, enable a user of the user device to perform an action in relation to an NFT stored in the ledger data 128. In some embodiments, the Asset Application is configured to receive requests from a user of the user device and perform one or more actions in response to those requests. In some embodiments, the Asset Application is configured to relay requests to the asset controller device, which can then make a determination as to whether the user (and more particularly the user device) has permission to complete the requested action. In some cases, the asset controller device may be configured to perform the request upon receiving it and determining that the action is a permitted action.

In some embodiments, the Asset Application 114 may be configured to, in conjunction with the processor 218, generate an eMEID that can be used to authenticate ownership of an asset via the electronic ledger. In some embodiments, the eMEID is generated by tokenizing or hashing information that relates to the user device and/or the asset itself. For example, a name or serial number for the asset may be combined with an identifier for the user device to generate an eMEID. In these embodiments, it should be appreciated that ownership may be authenticated by virtue of the eMEID only being able to be generated by a user device in possession of the underlying information used to generate it. The eMEID may be provided to the asset controller device to be used to add a record to the electronic ledger or authenticate ownership of a record.

In some embodiments, the Asset Application 114 may be configured to present information for an NFT on a display of the user device. In these embodiments, the Asset Application may relay a request to view the NFT to the asset controller device as noted above. Upon making a determination that the user device is permitted to view the NFT, the asset controller device may (provided that the user device does have permission) retrieve a cryptographic key associated with the NFT and relay that cryptographic key back to the Asset application on the user device. Upon receiving the cryptographic key, the Asset application may be configured to retrieve the NFT from the ledger data 128 (e.g., stored on a node device 202) and decrypt it using the cryptographic key. Once decrypted, the information stored within the NFT may be presented on the display of the user device.

The node device 202 can include any computing device configured to host ledger data 128. The asset controller device 102 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. The node device 202 can include one or more virtual machines running virtual operating systems, or other computing architectures involving virtualization such as one or more flexible pools of logical storage devices that can be virtualized to maintain virtual storage devices for the computer. For example, the asset node device 202 may include virtual computing devices in the form of virtual machines or software containers that are hosted in a cloud. In some cases, the node device 202 may include a computing device within a network of geographically-distributed computing devices.

In some embodiments, the ledger data 128 may be maintained across a number of different node devices. For example, a copy may be maintained on each node device in a network of such node devices. In this example, only one node device is able to update the ledger data at a time and an updated copy of the ledger data may be distributed to each node device as it is updated.

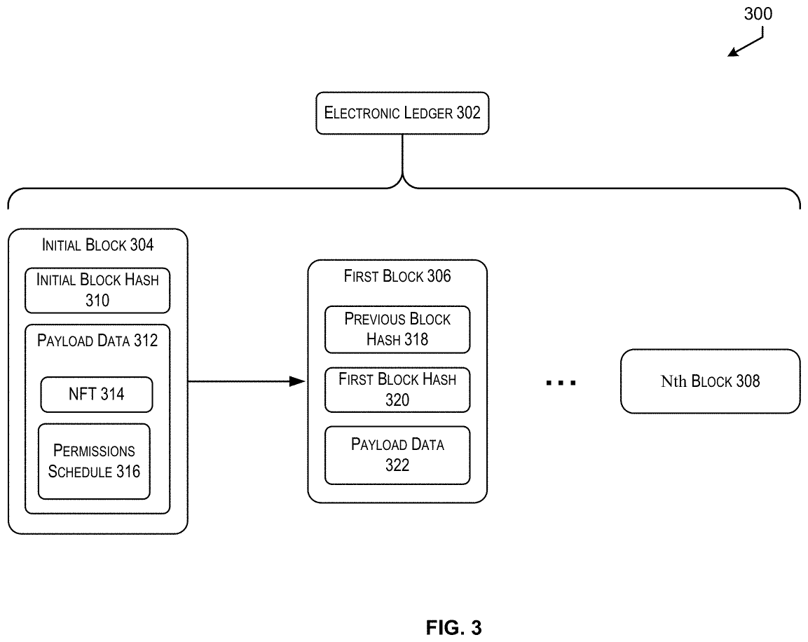

FIG. 3 illustrates a block diagram representing an exemplary electronic ledger that may be implemented in accordance with some embodiments. As noted elsewhere, the electronic ledger 302 may be a blockchain that includes a series of data blocks having at least an initial block 304, a first block 306 and a number of subsequent blocks, up to an n^{th} block 308.

The initial block 304 may include a number of components, including some combination of an initial block hash 310 and payload data 312. The initial block hash 310, when included, may correspond to a cryptographic hash of the content of the initial block, namely the initial payload data. In one embodiment, the payload data 312 included in the initial block may include information associated with an NFT 314, such as a link to a location in which the NFT is stored, image data, or an identifier (e.g., an enhanced MEID associated with the NFT).

Additionally, the initial block 304 may include a permissions schedule 316 that memorializes ownership, access, and modification rights to the asset. Using such a permissions schedule, the owner of the asset may control sale, transfer, publication, dissemination, and modification of records relating to the asset via a verifiable blockchain. In the permissions schedule, a mapping may be maintained of various user devices (e.g., via device identifier such as an MEID) to permissions associated with those user devices.

The first block 306, which is appended to the electronic ledger subsequent to the initial block 304, may include a previous block hash value 318, a first block hash value 320, and a payload data 322. One or more of the hash values described herein may be Merkle Root hash values. The previous block hash value 318 may correspond to a copy of the cryptographic hash of the preceding block within the blockchain, which in the case of the first block 306 immediately succeeding the initial block 304, corresponds to the initial block hash 310. The first block hash 320 may correspond to a cryptographic has of the content of the first block, namely the first Merkle root hash and the first payload data. The initial block hash and the first block hash may be generated using a digital signature algorithm such as HMAC with SHA256, ECDSA, or RSASSA-PSS. The n^{th} block 308 may include similar data to the first block, but may represent the latest status with respect to the NFT.

The payload data 322 may include digital assets (or information about the digital assets), a current permission schedule, or any other suitable information pertaining to an NFT. For example, if the enhanced MEID is associated with a mobile device, the digital assets may include images captured by a camera of the mobile device. As noted elsewhere, the payload data 322 may be encrypted via a cryptographic key associated with that payload data. In some embodiments, the cryptographic key may be associated with a particular data block on the electronic ledger, such that each data block is encrypted using a different cryptographic key. In some embodiments, the cryptographic key may be associated with a particular NFT, such that each data block associated with the NFT is encrypted via that cryptographic key. It should be noted that the payload data may include any suitable information to be secured in the electronic ledger. In some cases, such information may include an artwork such as a sound clip, video, or image, or a link or reference location to the artwork. In some cases, such information may include personal record information, such as a health record, financial information, or other person-specific data.

In some embodiments, a mobile device in communication with the electronic ledger may include a native application (e.g., Asset application 114 as described in relation to FIG. 1) that provides digital assets captured, generated, modified, or transmitted, at the mobile device, for incorporation into the blockchain. In some embodiments, the digital assets may further include a geolocation tag and timestamp to indicate a location and timing of when those digital assets were captured. The native application may monitor digital assets on the mobile device continuously, per a predetermined schedule, or in response to a triggering event. The predetermined schedule may correspond to any time interval, such as one minute, 30 minutes, one hour, or every several hours. The triggering event may correspond to detecting an operation of a camera, or transfer of digital assets via the network or transport layer of the mobile device.

Moreover, the native application may monitor software applications installed on the mobile device. Here, the native application may capture source code associated with the software application, generate payload data that includes the source code, and upload the [encrypted] payload data into a blockchain associated with the enhanced MEID of the mobile device. The payload data may further include metadata such as a timestamp of when the source code was uploaded as payload data.

In some embodiments, payload data, prior to being incorporated into a data block within the block chain may be encrypted using a cryptographic key (e.g., a private key of an asymmetric key pair) that is associated with an owner of the NFT/enhanced MEID. While blockchain technology may protect the integrity of payload data, encryption of the payload data provides further confidentiality and authentication protections.

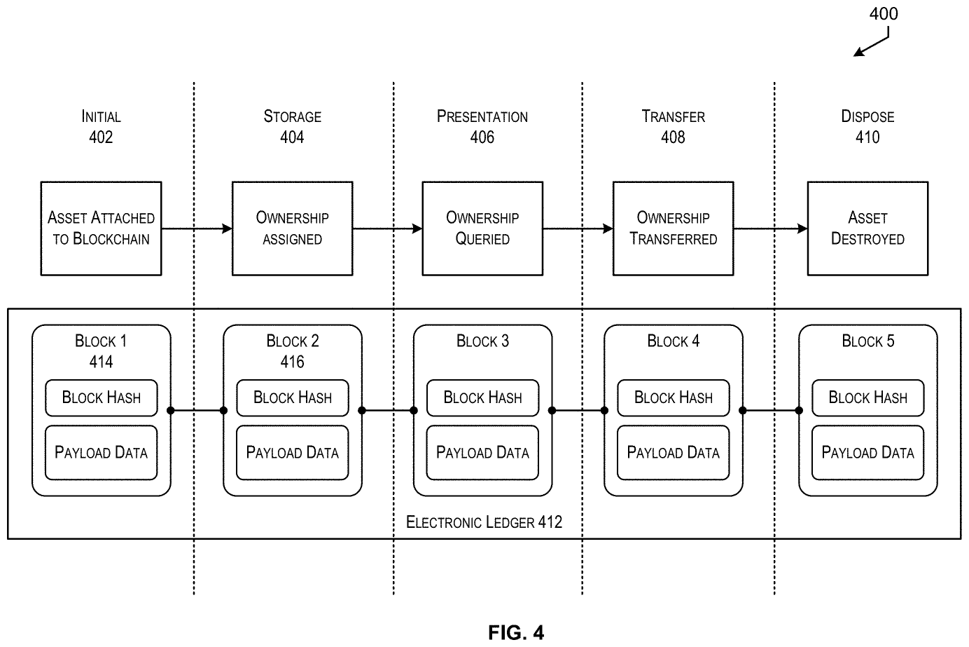

FIG. 4 illustrates a block diagram representing a series of exemplary interactions that may be performed in relation to an electronic ledger in accordance with some embodiments. Particularly, FIG. 4 illustrates a process 400 that includes a series of example interactions 402, 404, 406, 408, and 410. However, it should be noted that the interactions performed in embodiments of the disclosure may not be limited to the types of interactions depicted in the process 400. As noted elsewhere, the electronic ledger 412 (which may be an example of the electronic ledger 106 as described with respect to FIG. 1 above) may be a blockchain ledger. In some embodiments, each block in such a blockchain ledger may relate to a change in status for an asset, such that a current status for the asset may be determined by retrieving, and interpreting, the latest block of data appended to the blockchain in relation to that asset.

In the process 400, a record may be attached to the blockchain for an asset during an initial step 402. In this step, a first block 414 is created that includes a unique identifier for the asset (e.g., an NFT) as well as payload data that includes information about the asset. In some embodiments, the payload data includes a reference (e.g., a link) to a location in memory at which the asset is stored. In some cases, the payload data is encrypted using a cryptographic algorithm. Such encryption may be performed using a cryptographic key associated with the asset and/or data record, which may be either an asymmetric (i.e., paired) or symmetric cryptographic key. In some cases, a hash value (i.e., a hash block) may be generated from the payload data. This ensures that any changes to the payload data can be detected at a later date.

Once the initial block has been generated to include the asset (or a link thereto) an ownership interest in the asset is assigned at step 404. To do this, an identifier such as an eMEID is attached to the asset via a second data block 416 that updates the status of the asset. In some embodiments, the payload data for data block 416 may include any information to be added about the asset, including any change in status. Additionally, the payload data for data block 416 may include the asset, a link to a location at which the asset is stored, or a reference to the payload data included in data block 414. In some cases, information about the owner and/or a user device operated by the user (e.g., an MEID) may be stored in relation to the asset in data block 416.

At step 406, one or more permissions associated with the asset may be updated for presentation. For example, the one or more permissions may be updated to enable any user device to access the asset (or an abridged version of the asset) within limited access rights. In some cases, the asset may be marked as public and/or may be published to a marketplace for sale. Upon enabling presentation of the asset to the public, one or more actions may be requested in relation to the asset. For example, before completing a purchase, a prospective purchaser may submit a query to verify the ownership of the asset. Upon receiving such a query, a portion of the information stored in relation to the asset may be provided to the submitter of the query so that ownership can be verified. In some cases, such information may include an image, a physical description, one or more serial numbers, a geolocation, a current owner, or any other information that can be used to determine the authenticity of the physical asset.

At step 408, an ownership transfer may be initiated with respect to the asset. In such a case, authentication of owner authorization may be required, as verified via the eMEID.

In some cases, the request to transfer the ownership of the asset may originate from a user device operated by an owner of the asset. The request may include an eMEID to be used to authenticate the ownership interest as well as an indication of a transferee to which the ownership is to be transferred. Upon verifying the authenticity of the ownership of the asset, a request may be transmitted to a user device associated with the transferee for a new eMEID to be associated with the asset after the transfer of ownership.

In some cases, the request to transfer the ownership of the asset may originate at a transferee user device. Such a request may include an eMEID to be associated with the asset after the ownership transfer is complete. In this scenario, upon receiving the request to transfer ownership of the asset, a request may be transmitted to a user device associated with the owner to receive authorization. In response to sending the request, the user device associated with the owner may provide approval to perform the transfer. Such a response may include an eMEID to be used to authenticate the ownership of the asset.

Once the transfer of ownership has been authorized, and once the eMEID associated with the current owner has been verified, a new data block may be generated and appended to the electronic ledger that reflects the new ownership of the asset. In some embodiments, the new data block may include the eMEID provided by the transferee, such that the transferee has an ownership interest in the asset moving forward. In some embodiments, once the ownership transfer has been completed, permissions associated with the asset may be reset, such that the asset is no longer publicly accessible.

In some embodiments, an asset may be destroyed or otherwise disposed of at step 410. To do this, a status of the asset may be updated in the electronic ledger to reflect the new ownership interest in the asset. In some embodiments, such an action may correspond to a destruction of the underlying physical asset. In some cases, such an action may also require authentication of an ownership interest based on an eMEID received in the request.

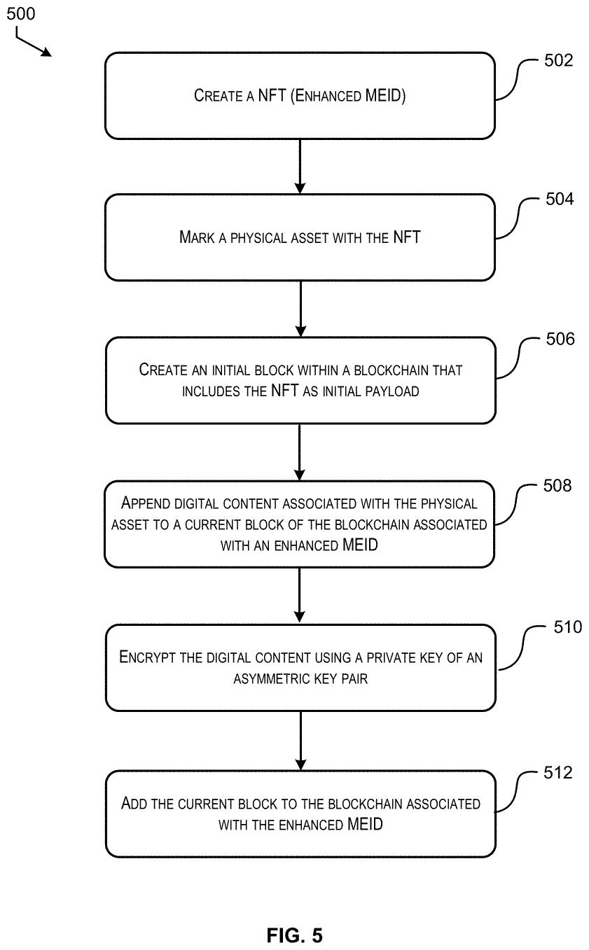

FIG. 5 illustrates a flow diagram illustrating a process 500 for generating and appending information associated with an asset to an electronic ledger in accordance with embodiments. More particularly, the process 500 depicts techniques by which information for an asset may be added to a blockchain ledger as well as techniques by which information for the asset may be modified on that blockchain ledger.

In the process 500, each block of a blockchain that tracks asset ownership is associated with at least one identifier (e.g., an enhanced MEID). In the illustrated example, the data block may be associated with a physical asset (e.g., a mobile device, camera device, painting, or other tangible asset), or a digital asset (e.g., an image asset, audio asset, video asset, or any other suitable multimedian asset). With regards to physical assets, the physical asset may include an obfuscated version of an identifier associated with the asset on the blockchain. For example, the physical asset may include a hash value generated from the identifier that is etched (e.g., burned) onto the physical asset to create an association between the physical asset and the digital record associated with the asset, within the block chain.

At block 502, an asset controller may generate a non-fungible token (NFT) to be associated with the asset. In some cases, the NFT may be generated from, or based on, a Mobile Equipment Identifier (MEID) associated with a user device from which the request originated. In some cases, the NFT may be a cryptographic token. In some cases, the NFT is created by generating a hash of information associated with the asset (e.g., physical asset or digital asset), such as a serial number or other identifier.

In embodiments, NFTs are generated using a one-way function (e.g., cryptographic hash). In other words, the NFT itself cannot be used to reconstitute the asset information upon which it was based. For example, an NFT created based on an image of a “signed” clothing article cannot be used to re-generate the image of the “signed” clothing article. That said, the benefit of a blockchain is that the asset information can be stored alongside the NFT in the initial block of the blockchain. As a result, any question of authenticity (e.g., NFT is inadvertently associated with a counterfeit physical asset), can be resolved by referring to the initial block of the blockchain.

At block 504, if the NFT is associated with a physical asset, the NFT may correspond to a hash of an identifier (e.g., an MEID or serial number). In some cases, the NFT (hash of the identifier) may be etched onto the physical asset to create an association between the physical record and the NFT, when stored within the blockchain. If the NFT is associated with a digital asset, the NFT may correspond to a hash of an identifier (such as an MEID), a hash of information for the digital asset, or a suitable combination of both.

At block 506, an Asset controller may create an initial block within a blockchain that includes the NFT and/or information associated with the asset as its initial payload. At least a portion of the payload data may be selectively encrypted using a private key of an asymmetric key pair associated with an owner of the NFT (or owner of the asset associated with the NFT).

Once the initial block has been added to the blockchain in association with an asset, a request may be received to modify information for that asset. For example, a request may be received to append digital content to the blockchain for an asset associated with an NFT.

At block 508, the Asset controller may receive digital content associated with a physical or digital asset. In one embodiment, the digital content may be uploaded as payload data into the blockchain by an owner of the underlying physical or digital asset. Alternatively, or additionally, the digital content may be captured, unobtrusively, by an application native on a physical asset that captures the digital content. For example, the physical asset may include a camera. An application native to the camera may be configured to capture digital content from the camera and uploaded the digital content to the blockchain continuously, on a predetermined schedule, or in response to a triggering event.

In some embodiments, the Asset controller may append metadata to the digital content, such as a time stamp and geolocation data that describes when and where the digital content was created, modified, or captured. The Asset controller may further append one or more rules associated with dissemination of the digital content, such as publication approval, distribution approval, sale approval, and/or so forth.

At block 510, the Asset controller may selectively encrypt the payload data using a private key of an asymmetric key pair that is associated with an owner of the digital content or underlying asset on the blockchain.

At block 512, the Asset controller may generate a subsequent block to the blockchain that includes the payload data of the digital content. Similar to the process described with reference to FIG. 3, the subsequent block may include i) the hash of the preceding block within the blockchain, ii) a hash of the payload data and the preceding block hash, and iii) the encrypted payload data.

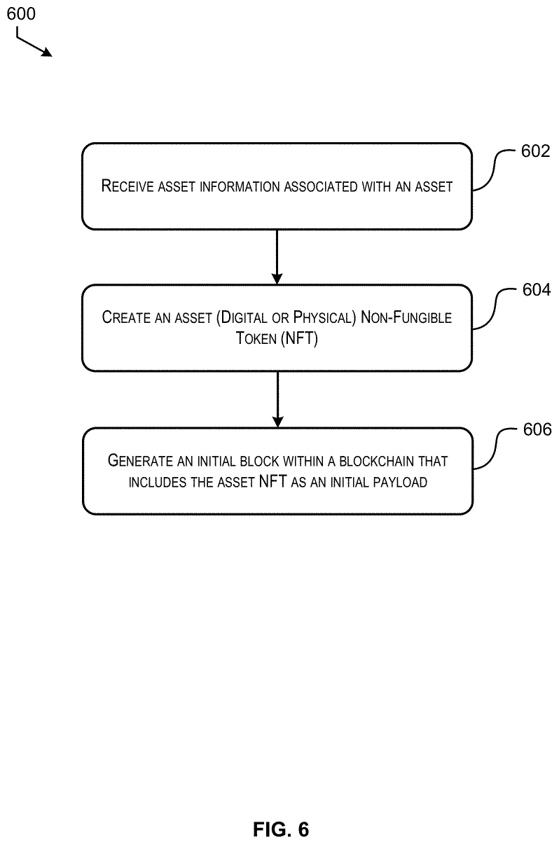

FIG. 6 illustrates a process flow for generating a block on a blockchain that incorporates an asset NFT in accordance with some embodiments. As noted elsewhere, the asset NFT may be associated with a digital asset or a physical asset. At block 602, an Asset controller may receive asset information associated with an asset (e.g., a digital asset or a physical asset. The asset information may be associated with an entirety of the asset or a portion of the asset that is less than its entirety.

At block 604, the Asset controller may create the asset NFT by generating a cryptographic hash of at least a portion of the asset information. The NFT may be uploaded into a distributed ledger, such as a blockchain, to memorialize its association with the asset. In some embodiments, an indication of the asset NFT may be embedded within the digital asset and/or physical asset. With regards to a digital asset, the Asset controller may perform acts to embed the asset NFT as metadata to the digital asset. In this way, the asset NFT accompanies the digital asset instance. With regards to a physical asset, the Asset controller may perform acts to embed the asset NFT within an RF tag, or similar electronic component, that is fixedly connected to the physical asset.

At block 606, the Asset controller may generate an initial block of a blockchain associated with the asset NFT. The initial block may include the asset NFT, ownership rights associated with the underlying asset (e.g., as included within a permissions schedule), and any other data pertinent to the asset or NFT. In some examples, the initial block may further include asset information (e.g., a portion or entirety of the digital asset, or image or part thereof of a physical asset) used to generate the NFT. For digital assets, the initial block may also include access controls that indicate which electronic devices may access the digital rights. Access control rights may be predicated on electronic device NFTs, whereby an NFT that is specific to an electronic device is generated based on its MEID. Further, the initial block may include a cryptographic key that grants access to an unabridged instance of a digital asset, based on verifying access control rights and/or ownership.

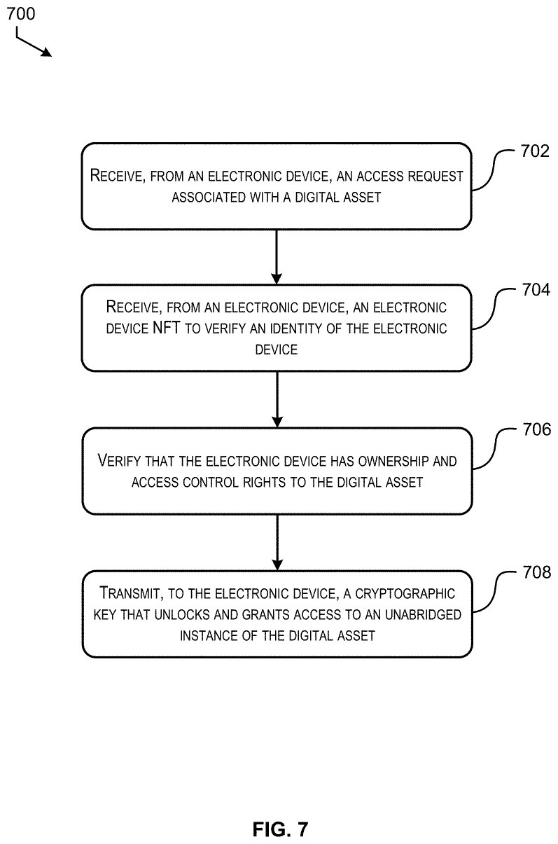

FIG. 7 illustrates a process flow for accessing an unabridged digital asset at an electronic device in accordance with some embodiments. In this embodiment, an asset NFT associated with a digital asset is stored within a blockchain. The initial block of the blockchain may include ownership and access rights of the digital assets. Ownership and access rights may be tied to NFTs of electronic devices. An electronic device NFT may be created using an identifier (e.g., an MEID) of the electronic device. The initial block, and any subsequent data block, may further include a cryptographic key that unlocks and grants access to an unabridged instance of a digital asset, based on verifying ownership and access rights.

At 702, the Asset controller may receive, from an electronic device, an access request associated with a digital asset. In some embodiments, the digital asset may be available within a public forum, in an abridged instance. That is, the length and/or quality of the digital asset may be modified for public dissemination. The access request may relate to accessing an unabridged instance of the digital asset, which is premised on verifying ownership and/or access control rights. For example, a thumbnail image may be publicly available that depicts (at a low resolution) an image. In this example, an unabridged version of the image may include a high-resolution image, which may be encrypted and stored in a secure location.

At 704, the Asset controller may receive from the electronic device, a hashed data value generated from an electronic device identifier that can be used to verify the identity of the electronic device. For example, the electronic device may generate such a hashed data value by combining at least a portion of a device identifier (e.g., an MEID) and information about the NFT or asset to be accessed. The combined information may then be subjected to a hash algorithm to generate the hashed data value. The identity of the electronic device may then be verified by comparing the hashed data value to a corresponding hashed data value stored in relation to the NFT. In some embodiments, the Asset controller may verify the authenticity of the hashed data value via a Certificate Authority (e.g., mutually trusted authority).

At 706, upon verifying the identity of the electronic device, the Asset controller may compare the identity with the ownership and access control rights of the digital asset (e.g., within the permissions schedule). Upon determining that the identity associated with the electronic device retains ownership, or at least access rights, of the digital asset, the Asset controller may transmit, to the electronic device, a cryptographic key that unlocks and grants access to an unabridged instance of a digital asset. In some embodiments, the Asset controller may also provide a link or other reference to a location at which the asset is stored (e.g., a location on a server).

By way of example, consider an audio stream available via an online service. The audio stream may be publicly available in an abridged instance, and access to an unabridged instance may be tied to verifying ownership or access rights via an NFT of the audio stream. The abridged instance may permit playback for a segment of the audio stream that is less than its entirety. Alternatively, or additionally, the abridged instance may permit playback of a low bitrate of the audio stream. The audio stream may be configured such that to access the unabridged instance (e.g., an entirety of the audio stream, relatively higher bitrate of the audio stream), the audio stream requires a cryptographic key. The cryptographic key may be stored within the blockchain associated with the audio stream NFT. Once an electronic device can provide proof of ownership of access rights, the cryptographic key may be sent to the electronic device to permit payback of the unabridged instance on the electronic device. In some examples, proof of ownership may be based on an electronic device NFT. The electronic device NFT may be based on a Mobile Equipment Identifier (MEID) of the electronic device. The MEID is a globally unique 56-bit identification number that is associated with an electronic device. Typically, equipment identifiers, such as MEIDs, are permanently etched into the physical structure of the mobile device, enabling consumers and vendors to identify and track an electronic device. Use of a MEID as proof of ownership and to control access rights provides control and access, at a per-device level, to the digital asset. Further, an NFT that is based on a MEID ensures that cloned or counterfeit electronic devices that purport to hold a MEID with access to a digital asset, are not inadvertently provided access rights to the unabridged digital asset.

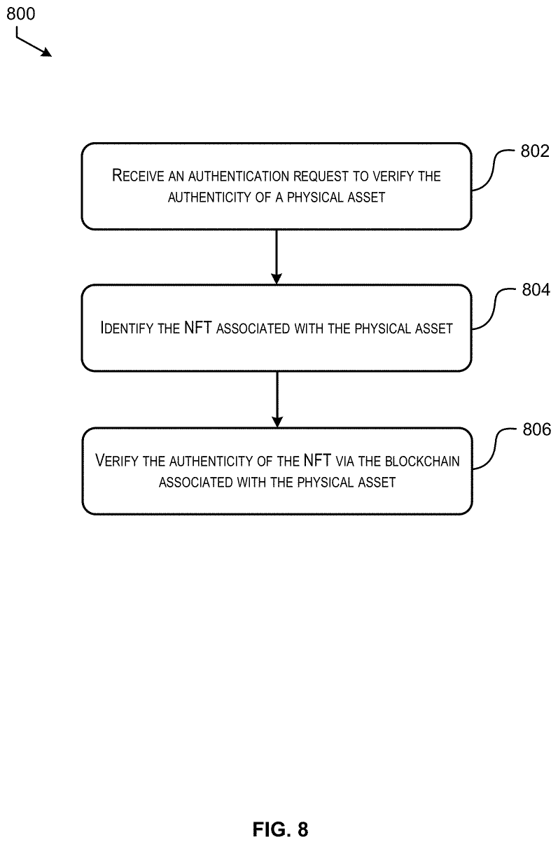

FIG. 8 illustrates a process flow for verifying authenticity and ownership of a physical asset at an electronic device in accordance with some embodiments. In the illustrated example, the Asset controller may receive an authentication request for the authenticity of a physical asset. The authentication request is premised on receiving an indication of an NFT and verifying the authenticity of the NFT and its association with the physical asset and/or an alleged owner.

At 802, the Asset controller may receive an authentication request to verify the authenticity of a physical asset. The Asset controller may receive the authentication request via an Asset application native to an electronic device (e.g., Asset application 114 described with respect to FIG. 1). The Asset application may act as an intermediary platform between the electronic device and the Asset controller. Alternatively, the Asset application may perform substantially all functions of the Asset controller.

In some embodiments, the authentication request may include an image of the physical asset that purports to represent the NFT. In these embodiments, such an image may include a character string that purports to be the character string of the NFT (e.g., cryptographic hash). Alternatively, if the NFT is stored within an RF tag or similar electronic component, that is fixedly connected to the physical asset, the authentication request may include a data file that includes the NFT character string. In some embodiments, the authentication request may include at least one data value obtained by interpreting a machine-readable code (e.g., a barcode or QR code) located upon the physical asset.

At 804, the Asset controller may interrogate the authentication request to identify the NFT associated with the physical asset. For example, one or more machine vision techniques (e.g., optical character recognition (OCR)) may be used to identify the characters in the character string from the image.

At 806, the Asset controller may verify the authenticity of the NFT via the blockchain associated with the physical asset. In some examples, the Asset controller may retrieve ownership information and asset information (e.g., images, etc.) associated with the physical asset for display on the electronic device associated with the authentication request. In this example, the asset information may be presented on a display of the electronic device so that a user of the electronic device can perform manual verification of the asset's authenticity based on that asset information. By way of illustration, the asset information may include an image, a physical description, one or more serial numbers, a geolocation, a current owner, or any other information that can be used to determine the authenticity of the physical asset.

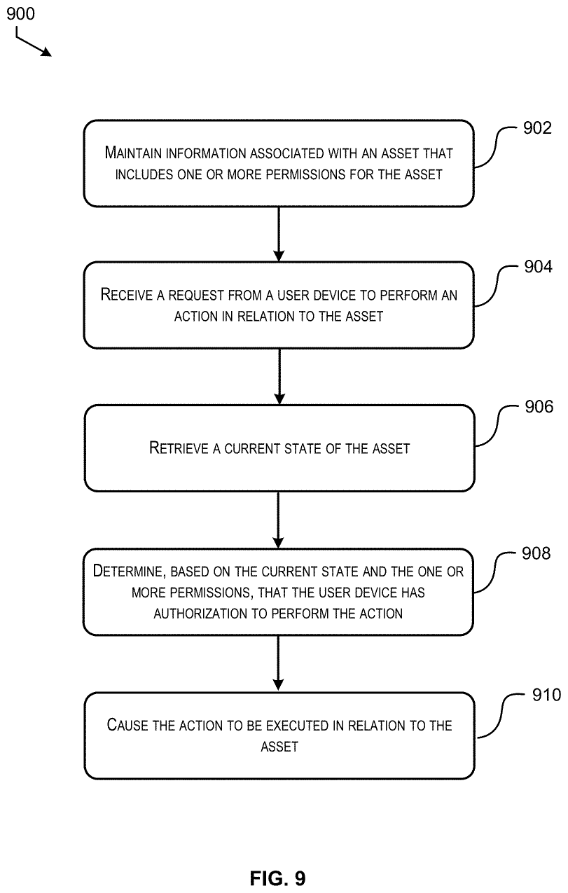

FIG. 9 depicts a flow diagram showing a process flow 900 for processing requests for an asset in relation to an electronic ledger in accordance with embodiments. The process 900 may be performed by a computing device that is configured to manage access to information stored on an electronic ledger. For example, the process 900 may be performed by an asset controller device 102 and described with respect to FIG. 1 above. In some embodiments, the electronic ledger includes a blockchain ledger. In some embodiments, a number of copies of the electronic ledger are stored on a number of node computing devices that form a geographically distributed network of computing devices.

At 902, the process 900 involves maintaining, on an electronic ledger, information associated with an asset. In embodiments, the information includes an enhanced Mobile Equipment Identifier (eMEID) and one or more permissions for the asset that are modifiable only upon authentication of the eMEID. In some embodiments, the one or more permissions for the asset includes a permissions schedule that correlates a number of user devices with actions that may or may not be performed by respective user devices in the number of user devices.

At 904, the process 900 involves receiving, from a user device, a request to perform an action in relation to the asset, the request may include at least an identifier for the user device. In some embodiments, the action to be executed in relation to the asset includes an action of transferring ownership of the asset and the request further includes at least a second identifier associated with a transferee user device. In some embodiments, the action to be executed in relation to the asset is an action to associate metadata with the digital asset. In some cases, the action to be executed in relation to the asset is an action to associate metadata with the digital asset. In at least some of these cases, the metadata includes a timestamp and geographic coordinates that identify when and where the digital asset was accessed, created, modified, or transmitted.

At 906, the process 900 involves retrieving, from the electronic ledger, a current state of the asset. In some embodiments, retrieving the current state of the asset involves retrieving a latest data block associated with the asset and determining a status based on the latest data block.

At 908, the process 900 involves determining, based on the identifier for the user device and the one or more permissions for the asset in the current state, that the user device is authorized to perform the action. In some embodiments, this may involve checking a permissions schedule to determine what permissions, if any, the requesting user device has with respect to the asset.

At 910, the process 900 involves causing the action to be executed in relation to the asset. In some embodiments, causing the action to be executed in relation to the asset includes providing a cryptographic key to the user device, the cryptographic key capable of being used to decrypt an encrypted version of information related to the asset. In some cases, the method further involves providing a location reference to the user device, the location reference indicating a location at which the encrypted version of information related to the asset is stored. In some embodiments, causing the action to be executed in relation to the asset is an action to perform the action on behalf of the user device by appending a new data block to the electronic ledger.

In some embodiments, the action is an action to transfer ownership of the asset or modify the one or more permissions. In such embodiments, the request may further include a generated hash value and the method further involves comparing the eMEID to the received generated hash value. The generated hash value may be a data value generated by subjecting at least an identifier for the user device to a hash algorithm.

In some embodiments, the action is an action to authenticate the asset and method further involves presenting at least a portion of the information associated with the asset on the user device to enable authentication of the asset. In at least some of those embodiments, the portion of the information includes at least one of an image, a physical description, one or more serial numbers, a geolocation, a current owner, or any other information that can be used to determine the authenticity of the physical asset.

The specification and drawings are to be regarded in an illustrative rather than a restrictive sense. It will, however, be evident that various modifications and changes may be made thereunto without departing from the broader spirit and scope of the disclosure as set forth in the claims. The embodiments described herein may be implemented on executable software that runs on one or more computing devices. The one or more computing devices may be equipped with a communication interface, a user interface, one or more processors, and memory.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as being essential to the practice of the invention.

Preferred embodiments of this disclosure are described herein, including the best mode known to the inventors for carrying out the invention. Variations of those preferred embodiments may become apparent to those of ordinary skill in the art upon reading the foregoing description. The inventors expect skilled artisans to employ such variations as appropriate and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### CONCLUSION

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims in the set of claims.

1. A method comprising:
maintaining, on an electronic ledger, information associated with an asset, the information comprising an enhanced Mobile Equipment Identifier (eMEID) and one or more permissions for the asset that are modifiable only upon authentication of the eMEID;
receiving, from a user device, a request to perform an action in relation to the asset, the request comprising at least an identifier for the user device;
retrieving, from the electronic ledger, a current state of the asset;
determining, based on the identifier for the user device and the one or more permissions for the asset in the current state, that the user device is authorized to perform the action; and
causing the action to be executed in relation to the asset.

2. The method of claim 1, wherein the electronic ledger comprises a blockchain ledger.

3. The method of claim 1, wherein causing the action to be executed in relation to the asset comprises providing a cryptographic key to the user device, the cryptographic key capable of being used to decrypt an encrypted version of information related to the asset.

4. The method of claim 3, wherein the method further comprises providing a location reference to the user device, the location reference indicating a location at which the encrypted version of information related to the asset is stored.

5. The method of claim 1, wherein causing the action to be executed in relation to the asset comprises performing the action on behalf of the user device by appending a new data block to the electronic ledger.

6. The method of claim 1, wherein the action to be executed in relation to the asset comprises transferring ownership of the asset and the request further comprises at least a second identifier associated with a transferee user device.

7. The method of claim 1, wherein the action to be executed in relation to the asset comprises associating metadata with the digital asset.

8. The method of claim 7, wherein the metadata comprises a timestamp and geographic coordinates that identify when and where the digital asset was accessed, created, modified, or transmitted.

9. The method of claim 1, wherein retrieving the current state of the asset comprises retrieving a latest data block associated with the asset and determining a status based on the latest data block.

10. A computing device comprising:
a processor; and
a memory containing instructions that, when executed with the processor, cause the computing device to, at least:
maintain, on an electronic ledger, information associated with an asset, the information comprising an eMEID and one or more permissions for the asset that are modifiable only upon authentication of the eMEID;
receive, from a user device, a request to perform an action in relation to the asset, the request comprising at least an identifier for the user device;
retrieve, from the electronic ledger, a current state of the asset;
determine, based on the identifier for the user device and the one or more permissions for the asset in the current state, that the user device is authorized to perform the action; and
cause the action to be executed in relation to the asset.

11. The computing device of claim 10, wherein a number of copies of the electronic ledger are stored on a number of node computing devices.

12. The computing device of claim 10, wherein the number of node computing devices comprise a geographically distributed network of computing devices.

13. The computing device of claim 10, wherein the one or more permissions for the asset comprises a permissions schedule that correlates a number of user devices with actions that may or may not be performed by respective user devices in the number of user devices.

14. The computing device of claim 10, wherein the action comprises an action to transfer ownership of the asset or modify the one or more permissions, the request further including a generated hash value, the method further comprising comparing the eMEID to the received generated hash value.

15. The computing device of claim 10, wherein the generated hash value comprises a data value generated by subjecting at least an identifier for the user device to a hash algorithm.

16. The computing device of claim 10, wherein the action comprises an action to authenticate the asset and the instructions further cause the computing device to present at least a portion of the information associated with the asset on the user device to enable authentication of the asset.

17. The computing device of claim 16, wherein the portion of the information comprises at least one of an image, a physical description, one or more serial numbers, a geolocation, a current owner, or any other information that can be used to determine the authenticity of the physical asset.

18. A non-transitory computer-readable media collectively storing computer-executable instructions that upon execution cause one or more computing devices to collectively perform acts comprising:
maintaining, on an electronic ledger, information associated with an asset, the information comprising an eMEID and one or more permissions for the asset that are modifiable only upon authentication of the eMEID;
receiving, from a user device, a request to perform an action in relation to the asset, the request comprising at least an identifier for the user device;
retrieving, from the electronic ledger, a current state of the asset;
determining, based on the identifier for the user device and the one or more permissions for the asset in the current state, that the user device is authorized to perform the action; and
causing the action to be executed in relation to the asset.

19. The non-transitory computer-readable media of claim 18, wherein the electronic ledger comprises a blockchain ledger.

20. The non-transitory computer-readable media of claim 18, wherein causing the action to be executed in relation to the asset comprises providing a cryptographic key to the user device, the cryptographic key capable of being used to decrypt an encrypted version of information related to the asset.
